(19) United States
(12) Patent Application Publication
(10) Pub. No.: US 2008/0045158 A1
(43) Pub. Date: Feb. 21, 2008

(54) Method And System For Transmitting A Beacon Signal In A Wireless Network

(75) Inventor: Baowei Ji, Plano, TX (US)

Correspondence Address: DOCKET CLERK, P.O. DRAWER 800889, DALLAS, TX, 75380, US

(73) Assignee: SAMSUNG ELECTRONICS CO., LTD., SUWON-CITY (KR)

(21) Appl. No.: 11/760,398

(22) Filed: Jun. 8, 2007

Related U.S. Application Data
(60) Provisional application No. 60/838,095, filed on Aug. 15, 2006.

(51) Int. Cl. H04B 17/00

(52) U.S. Cl. 455/67.11

(57) ABSTRACT

A method for transmitting a beacon signal to facilitate quick beacon detection and protect a low-power device in a wireless network is provided. The method includes spreading each symbol of a beacon message with a fixed-length pseudorandom (PN) code to generate a beacon signal. The beacon signal is transmitted without a corresponding pilot signal.

### CROSS-REFERENCE TO RELATED APPLICATIONS AND CLAIM OF PRIORITY

The present application is related to U.S. Provisional Patent No. 60/838,095, filed Aug. 15, 2006, titled “Generic Beacon Design for Fast Beacon Detection Independent of Message Load.” U.S. Provisional Patent No. 60/838,095 is assigned to the assignee of the present application and are hereby incorporated by reference into the present disclosure as if fully set forth herein.

The present application hereby claims priority under 35 U.S.C. §119(e) to U.S. Provisional Patent No. 60/838,095.

### TECHNICAL FIELD OF THE INVENTION

The present application relates generally to wireless communication networks and, more specifically, to a method and system for transmitting a beacon signal in a wireless network.

### BACKGROUND OF THE INVENTION

Wireless regional area networks (WRANs) operate using a cognitive radio-based approach in which the target spectrum includes unused channels that have been allocated for television broadcast services. In order to avoid interference, TV broadcast stations that are being used in any given region may be detected and avoided by devices functioning as part of a WRAN. However, some low-powered devices, such as wireless microphones and other devices licensed under Part 74 of the Federal Communication Commission rules (i.e., Part 74 devices), are more difficult to detect and avoid than TV broadcast stations because of their low transmit power and other factors.

For example, some wireless microphones and other Part 74 devices have a limited coverage of around 200 meters. Thus, systems located far away (e.g., a base station located 30 km away) are unable to sense and protect those low-power devices. One proposed solution to this problem involves the use of a beacon device associated with a low-power device. The beacon device has a much larger coverage (e.g., around 35 km) and is thus able to alert other wireless systems to the presence of the low-power device. The challenges of designing such a beacon device include cost and high reliability of beacon signal detection.

In one proposed design, a long symbol is used for coping with multipath fading without using complicated signal detection methods, such as equalization, channel estimation, or OFDM modulation. One of the disadvantages of this design is that a long symbol implies a low data rate, which in turn requires a long sensing period for detecting the beacon signal. For example, about 4.567 msec are needed for detecting a 24-bit burst, and about 68.5 msec are needed for detecting a 360-bit beacon PSDU. This beacon design fails to meet the requirement in 802.22 FRD that the transmission of a low-power device needs to be detected and protected within two seconds. Therefore, there is a need in the art for an improved method for transmitting a beacon signal in a wireless network.

### SUMMARY OF THE INVENTION

A method for transmitting a beacon signal to facilitate quick beacon detection and protect a low-power device in a wireless network is provided. According to an advantageous embodiment of the present disclosure, the method includes spreading each symbol of a beacon message with a fixed-length pseudorandom code to generate a beacon signal and transmitting the beacon signal without a corresponding pilot signal.

According to another embodiment of the present disclosure, a method for detecting a beacon signal that is operable to protect a low-power device at a receiver in a wireless network is provided. The method includes detecting an energy level of a received signal. The detected energy level is compared to a detection threshold. The received signal is identified as a beacon signal when the detected energy level is greater than the detection threshold.

According to yet another embodiment of the present disclosure, a receiver capable of detecting a beacon signal that is operable to protect a low-power device in a wireless network is provided. The receiver includes an energy detector and a comparator. The energy detector is operable to detect an energy level of a received signal. The comparator is coupled to the energy detector and is operable to compare the detected energy level to a detection threshold and to identify the received signal as a beacon signal when the detected energy level is greater than the detection threshold.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network including receivers capable of transmitting a beacon signal according to an embodiment of the disclosure;

FIG. 2 illustrates details of the protecting device of FIG. 1 according to an embodiment of the present disclosure;

FIG. 3 illustrates a structure for the beacon signal transmitted by the protecting device of FIG. 2 according to an embodiment of the present disclosure;

FIG. 4 illustrates a receiver that is capable of detecting the beacon signal transmitted by the protecting device of FIG. 2 according to an embodiment of the present disclosure;

FIG. 5 illustrates details of the energy detector of FIG. 4 according to an embodiment of the present disclosure;

FIG. 6 is a flow diagram illustrating a method for transmitting a beacon signal from the protecting device of FIG. 2 according to an embodiment of the present disclosure; and

FIG. 7 is a flow diagram illustrating a method for detecting a beacon signal at the receiver of FIG. 4 according to an embodiment of the disclosure.

### DETAILED DESCRIPTION OF THE INVENTION

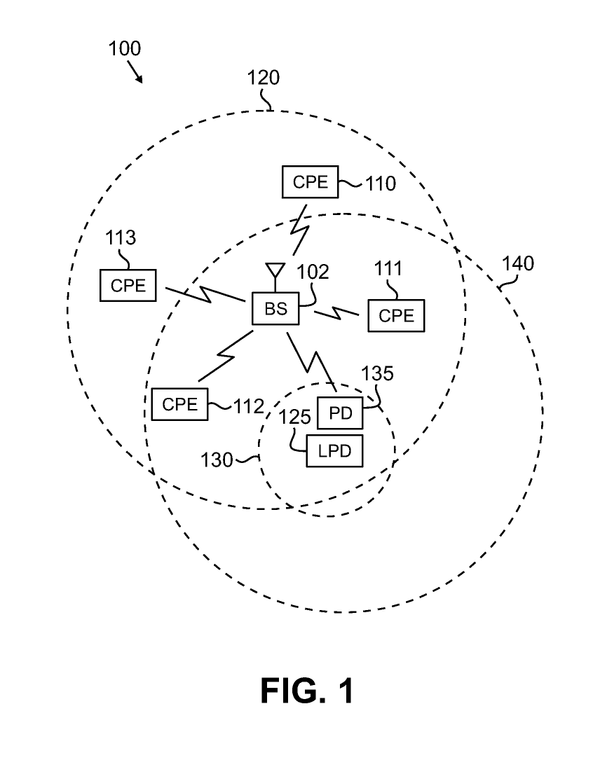

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

FIG. 1 illustrates a wireless network 100 including receivers capable of transmitting a beacon signal according to an embodiment of the disclosure. Wireless network 100 may comprise a wireless regional area network (WRAN). Wireless network 100 comprises at least one base station (BS) 102 that is operable to provide service to a plurality of non-interfering customer premises equipment (CPE) devices 110-113 within a cell 120.

As used herein, a “non-interfering CPE” means a device that is allowed to operate in the television bands on a non-interfering basis as part of wireless network 100. Thus, for example, if one or more particular channels allocated for broadcast television are unused in a particular region, a WRAN such as wireless network 100 may be implemented in which CPEs 110-113 are able to operate using the unused channels such that no interference is seen by the television channels that are being used.

Dotted lines show the approximate boundaries of cell 120 in which base station 102 is located. Cell 120 is shown approximately circular for the purposes of illustration and explanation only. It should be clearly understood that cell 120 may have other irregular shapes, depending on the cell configuration selected and variations in the radio environment associated with natural and man-made obstructions. Although the embodiment of FIG. 1 illustrates base station 102 in the center of cell 120, the system of the present disclosure is not limited to any particular cell configuration. Base station 102 is operable to manage wireless communication resources for cell 120.

Within cell 120, one or more low-power devices (LPDs) 125 may exist. As used herein, a “low-power device” means a wireless microphone or other Part 74 device or any other suitable device that may operate in the same television bands as CPEs 110-113 and that is operable to transmit within a limited coverage area 130. As used herein, a “limited coverage area” means a coverage area that is less than the range of base station 102. Thus, a signal transmitted by low-power device 125 travels a shorter distance (corresponding to limited coverage area 130) than a signal transmitted by base station 102 (which travels a distance corresponding to cell 120).

Therefore, base station 102 and CPEs 110-113 may be unable to detect the presence of low-power device 125 based on transmissions from low-power device 125 when low-power device 125 is not relatively close. As a result, when low-power device 125 is operating within the same unused television channels as base station 102 and CPEs 110-113, base station 102 and/or CPEs 110-113 may interfere with the operation of low-power device 125. For example, when low-power device 125 comprises a wireless microphone, signals transmitted by base station 102 or CPEs 110-113 may be received at a wireless microphone receiver that is receiving signals from the wireless microphone. Accordingly, the signals from base station 102 and/or CPEs 110-113 may interfere with the wireless microphone signals, causing the wireless microphone receiver to malfunction.

Therefore, in order for base station 102 and CPEs 110-113 to detect the presence of low-power device 125 and avoid interfering with its operation, a protecting device (PD) 135 may be provided for low-power device 125. Protecting device 135 is operable to transmit a beacon signal to nearby base stations, such as base station 102, and CPEs, such as CPEs 111-112, on the same channel in which the low-power device 125 is operating. The beacon signal comprises information relevant to low-power device 125, such as a physical location, estimated duration of channel occupancy, time, height of protecting device 135, and the like.

Protecting device 135 is operable to transmit the beacon signal a longer distance than the signals transmitted by low-power device 125. Thus, protecting device 135 may transmit the beacon signal within a protection zone 140 that is comparable to the size of a cell 120. For example, for one particular embodiment, cell 120 may comprise a radius of approximately 30 kilometers, limited coverage area 130 may comprise a radius of approximately 200 meters, and protection zone 140 may comprise a radius of approximately 35 kilometers. However, it will be understood that cell 120, limited coverage area 130 and protection zone 140 may be any suitable sizes.

Because protecting device 135 is able to transmit the beacon signal the larger distance associated with protection zone 140 (as compared to the shorter distance associated with limited coverage area 130), base station 102 and nearby CPEs 111-112 are operable to receive the beacon signal. Based on the beacon signal, base station 102 and nearby CPEs 111-112 are operable to avoid using the same portion of an unused television channel that is being used by low-power device 125. Therefore, low-power device 125 is protected by the beacon signal transmitted by protecting device 135.

As described in more detail below, base station 102 and CPEs 111-112 are each operable to detect the beacon signal based on the energy of the beacon signal itself. As a result, protecting device 135 does not need to transmit a pilot signal along with the beacon signal. In addition, because no pilot is needed, the beacon signal may be transmitted substantially continuously, and the beacon signal may be detected relatively quickly.

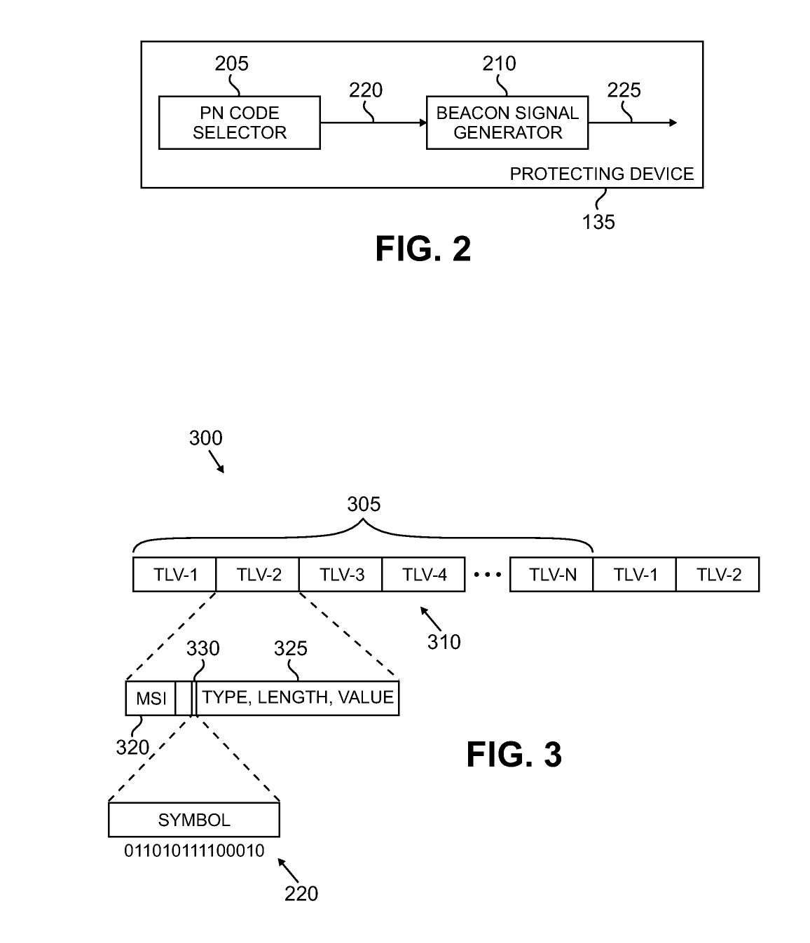

FIG. 2 illustrates details of protecting device 135 according to an embodiment of the present disclosure. Protecting device 135 comprises a pseudorandom (PN) code selector 205 and a beacon signal generator 210. Although illustrated and described as two separate components, it will be understood that PN code selector 205 and beacon signal generator 210 may be implemented together as a single component without departing from the scope of this disclosure. It will also be understood that protecting device 135 comprises additional components not illustrated in FIG. 2.

In order to mitigate collisions among protecting devices 135 in the same television channel, PN code selector 205 is operable to select a fixed-length PN code 220 from a plurality of possible PN codes for use in spreading the beacon signal. For one embodiment, PN code selector 205 is operable to select the PN code 220 randomly. For an alternate embodiment, PN code selector 205 may be operable to select the PN code 220 using any other suitable algorithm.

PN code selector 205 is operable to provide the selected PN code 220 to beacon signal generator 210. Beacon signal generator 210, which is coupled to PN code selector 205, is operable to generate a beacon message and to spread each symbol of the beacon message using the PN code 220 provided by PN code selector 205 in order to generate the beacon signal 225 for transmission. Protecting device 135 is operable to transmit the beacon signal 225 periodically in type-length-value (TLV) format.

FIG. 3 illustrates a structure 300 for the beacon signal 225 transmitted by protecting device 135 according to an embodiment of the present disclosure. Structure 300 comprises a repeating beacon period 305, one of which is illustrated in FIG. 3 along with a portion of a second one. For one embodiment, beacon period 305 lasts much less than one second.

Each beacon period 305 comprises N beacon data blocks 310, with N comprising any suitable number. Each beacon data block 310 comprises a message separation indicator (MSI) 320 and a beacon message 325, which comprises a plurality of symbols 330. The message separation indicator 320 may comprise any suitable symbol or plurality of symbols that are operable to indicate a separation between beacon messages 325 of consecutive beacon data blocks 310. Although illustrated at the beginning of the beacon data block 310, it will be understood that, for an alternate embodiment, the message separation indicator 320 may be placed at the end of the beacon data block 310.

The beacon message 325 provides the actual type, length and value data for the beacon data block 310. Each symbol 330 in the beacon message 325 is spread using the PN code 220 selected by PN code selector 205. Thus, for the illustrated embodiment, the PN code 220 comprises a value of ‘011010111100010.’ However, it will be understood that this is merely an example and that the PN code 220 may comprise any suitable value.

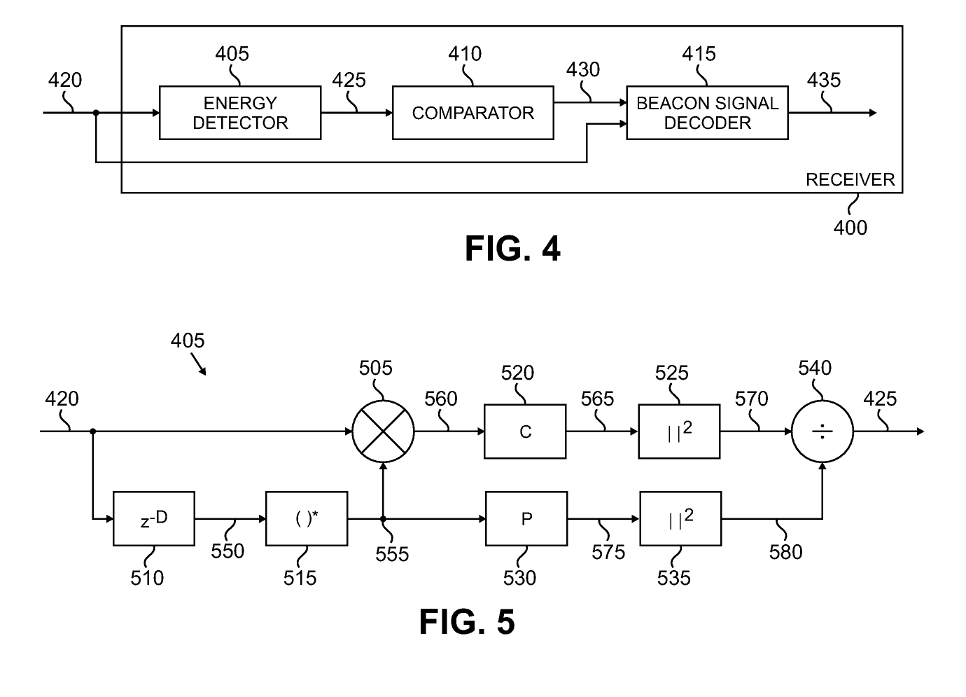

FIG. 4 illustrates a receiver 400 that is capable of detecting the beacon signal 225 transmitted by protecting device 135 according to an embodiment of the present disclosure. Thus, for one embodiment, receiver 400 may correspond to base station 102, CPE 111 or CPE 112 of FIG. 1. Receiver 400 comprises an energy detector 405, a comparator 410 and a beacon signal decoder 415. Although illustrated and described as three separate components, it will be understood that any two or all of energy detector 405, comparator 410 and beacon signal decoder 415 may be implemented together as a single component without departing from the scope of this disclosure. It will also be understood that receiver 400 comprises additional components not illustrated in FIG. 4.

Energy detector 405 is operable to receive a signal 420, which may or may not comprise the beacon signal 225, and to generate an accumulated signal 425 based on an energy level of the received signal 420. In order to generate the accumulated signal 425, energy detector 405 is operable to accumulate the signal energy of the received signal 420 for a predetermined amount of time. For example, for one embodiment, energy detector 405 is operable to accumulate the signal energy of the received signal 420 for one symbol period. For another embodiment, energy detector 405 is operable to accumulate the signal energy of the received signal 420 for two symbol periods. When the received signal 420 comprises noise, the accumulated signal 425 may comprise a value that is less than or equal to a detection threshold. Similarly, when the received signal 420 comprises the beacon signal 225, the accumulated signal 425 may comprise a value that is greater than the detection threshold.

Comparator 410, which is coupled to energy detector 405, is operable to receive the accumulated signal 425 and to compare the accumulated signal 425 to the detection threshold in order to determine whether the received signal 420 is noise or the beacon signal 225. Based on this comparison, comparator 410 is operable to generate a detection signal 430 for beacon signal decoder 415.

Beacon signal decoder 415, which is coupled to comparator 410, is operable to receive the detection signal 430 and the received signal 420. When the detection signal 430 identifies the received signal 420 as noise, beacon signal decoder 415 is operable to generate either no output signal 435 or an output signal 435 that indicates no beacon signal 225 is being received. When the detection signal 430 identifies the received signal 420 as the beacon signal 225, beacon signal decoder 415 is operable to decode the beacon signal 225 (i.e., the received signal 420) and to generate an output signal 435 that comprises the decoded beacon signal.

Although receiver 400 needs no pilot signal to detect the beacon signal 225, it will be understood that receiver 400 may detect the beacon signal 225 even when transmitted along with a pilot signal. For example, when a dual-channel beacon signal is transmitted with a pilot on one channel and a substantially continuous beacon on another channel, receiver 400 may detect the beacon signal 225 in the same manner.

For a particular embodiment, energy detector 405 is operable to accumulate signal energy for the received signal 420 for one symbol period in order to generate the accumulated signal 425. This embodiment provides the fastest detection of the beacon signal 225. Energy detector 405 may also be operable to accumulate the energy of multiple symbols in order to increase the probability of detecting the beacon signal 225.

For this embodiment, a detection threshold may be defined for use by comparator 410 in identifying the received signal 420 as noise or as the beacon signal 225. However, an accurate detection threshold is dependent on the distance between protecting device 135 and receiver 400, which may vary. Thus, accumulating energy for multiple symbols may be useful to more accurately detect the beacon signal 225 for this embodiment, while initially accumulating energy for a single symbol period may be useful in quickly detecting the beacon signal 225 for those situations in which the detection threshold is accurate.

For this embodiment, a metric, m, is defined as the energy of a symbol, which is calculated by the correlation of a symbol with itself, as follows:

$$\begin{matrix}{m}_{n} = {\sum }_{k = 0}^{D - 1} {r}_{n - k} {r}_{n - k} = {\sum }_{k = 0}^{D - 1} {\vert {r}_{n - k} \vert}^{2} & ( eqn . 1 ) \\ \text{and} & \\ {m}_{n + 1} = {m}_{n} + {\vert {r}_{n + 1} \vert}^{2} - {\vert {r}_{n - D + 1} \vert}^{2} , & ( eqn . 2 )\end{matrix}$$

where D is the number of chips in the PN code 220, k is the index of chips (0 through D−1), and r is the energy of a chip. Thus, compared to noise, the value of m should increase dramatically when the beacon signal 225 is received. For this embodiment, although D multiplications and D−1 additions are performed for a first symbol (as in equation 1), once the first m value is known the remaining m values may be calculated using two multiplications and two additions (as in equation 2).

For another particular embodiment, as described in more detail below in connection with FIG. 5, energy detector 405 is operable to accumulate signal energy for the received signal 420 for two symbol periods in order to generate the accumulated signal 425. For this embodiment, an accurate detection threshold may be defined for use by comparator 410 in identifying the received signal 420 as noise or as the beacon signal 225 regardless of the strength of the received signal 420.

FIG. 5 illustrates details of energy detector 405 according to a particular embodiment of the present disclosure. It will be understood that energy detector 405 may be implemented in any other suitable manner without departing from the scope of the present disclosure. For the illustrated embodiment, energy detector 405 is operable to accumulate signal energy for the received signal 420 for two symbol periods in order to generate the accumulated signal 425. For this embodiment, energy detector 405 comprises a spreader 505, a delay block 510, a complex conjugator 515, a two-symbol correlator (C) 520, a complex square block 525, a single-symbol correlator (P) 530, a square block 535, and a division block 540.

Spreader 505 and delay block 510 are both operable to receive the signal 420. Delay block 510 is operable to delay the received signal 420 by D chips (i.e., one symbol period) to generate a signal 550 for complex conjugator 515. Complex conjugator 515 is operable to provide a complex conjugate of the signal 550 to generate a signal 555 for spreader 505 and single-symbol correlator 530.

Spreader 505 is operable to spread the received signal 420 (which corresponds to a current symbol) based on the signal 555 (which corresponds to a previous symbol) to generate a signal 560 for the two-symbol correlator 520. Two-symbol correlator 520 is operable to correlate the current symbol with the previous symbol to generate a signal 565 for the complex square block 525. Complex square block 525 is operable to square the signal 565, which may comprise a complex value, to generate a signal 570 for the division block 540.

Single-symbol correlator 530 is operable to correlate the previous symbol with itself based on the signal 555 to generate a signal 575 for the square block 535. Square block 535 is operable to square the signal 575 to generate a signal 580 for the division block 540. Division block 540 is operable to divide the signal 570 by the signal 580 to generate the accumulated signal 425.

For this embodiment, a metric, m (which corresponds to the accumulated signal 425), is defined as the energy of a symbol pair, which is calculated by the correlation of a current symbol with a previous symbol, as follows:

$$\begin{matrix}{m}_{n} = \frac{{\vert {c}_{n} \vert}^{2}}{{( {p}_{n} )}^{2}} , & \\ \text{where} & \\ {c}_{n} = {\sum }_{k = 0}^{D - 1} {r}_{n + k} {r}_{n + k + D} & \\ \text{or} & \\ {c}_{n} = - {\sum }_{k = 0}^{D - 1} {r}_{n + k} {r}_{n + k + D} & \\ \text{and} & \\ {p}_{n} = {\sum }_{k = 0}^{D - 1} {r}_{n + k + D} {r}_{n + k + D .} & \end{matrix}$$

For this embodiment, c is the correlation of the previous symbol with the current symbol, and p is the correlation of the previous symbol with itself. When the received signal 420 is noise, the value of c will be zero. However, when the received signal 420 comprises the beacon signal 225, the value of c will be p or −p (depending on whether the two symbols are the same value or not).

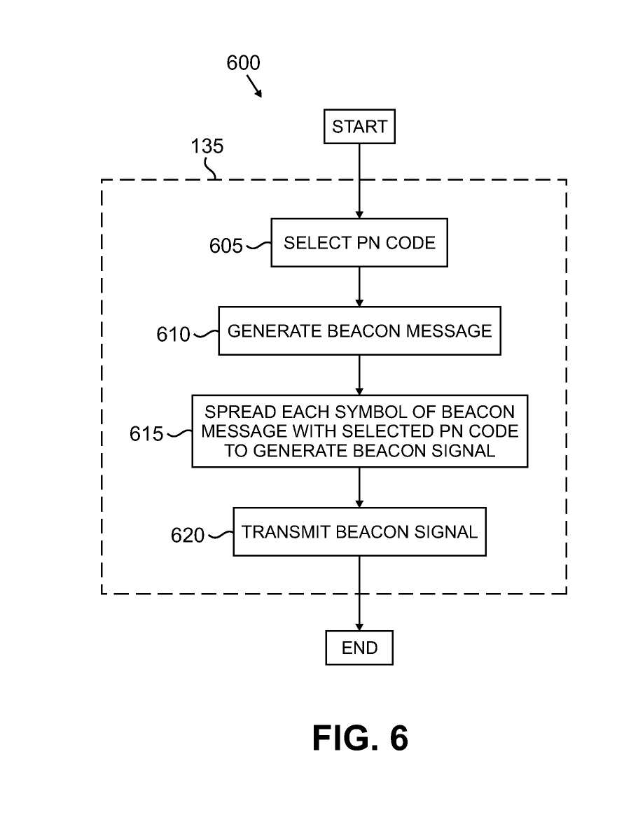

FIG. 6 is a flow diagram illustrating a method 600 for transmitting a beacon signal 225 from protecting device 135 according to an embodiment of the present disclosure. Initially, PN code selector 205 selects a PN code 220 based on any suitable algorithm (process step 605). For example, PN code selector 205 may randomly select a PN code 220 from a plurality of possible PN codes.

Beacon signal generator 210 generates a beacon message 325 comprising type, length and value data (process step 610). Beacon signal generator 210 spreads each symbol of the beacon message 325 with the selected PN code 220 to generate a beacon signal 225 (process step 615). For one embodiment, the beacon signal 225 comprises a plurality of repeating beacon data blocks 310 that each comprise a message separation indicator 320 and the beacon message 325 after spreading. Protecting device 135 then transmits the beacon signal 225 in order to protect a low-power device 125 (process step 620).

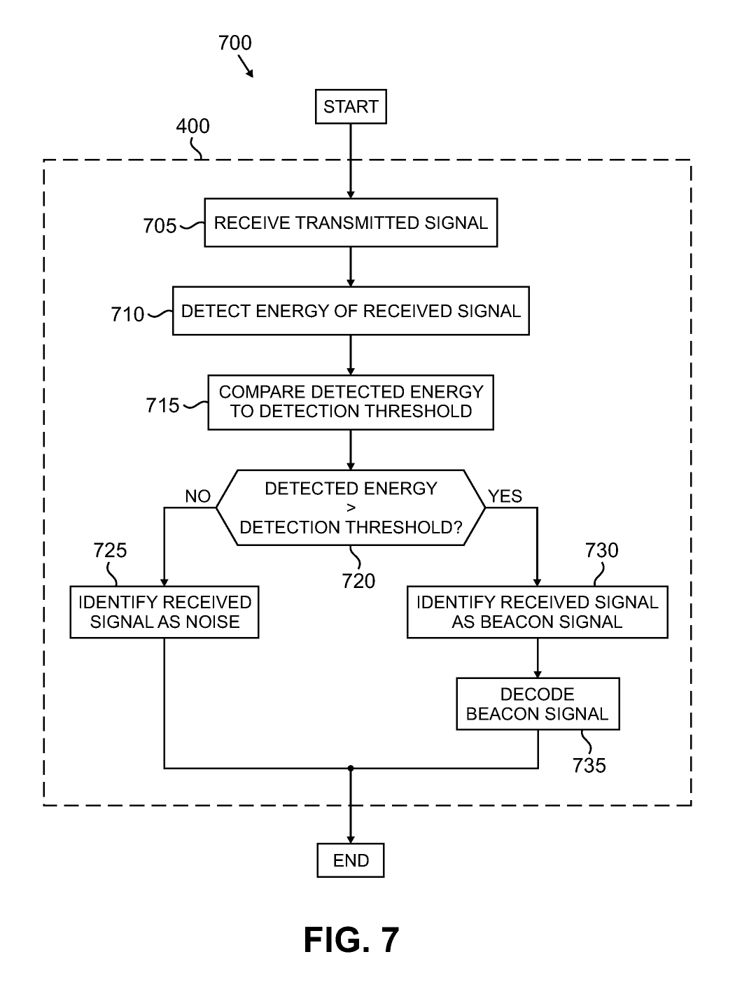

FIG. 7 is a flow diagram illustrating a method 700 for detecting a beacon signal 225 at receiver 400 according to an embodiment of the disclosure. Initially, a transmitted signal 420 is received at receiver 400 (process step 705). Energy detector 405 detects the energy of the received signal 420 (process step 710).

For one embodiment, energy detector 405 correlates a symbol in the received signal 420 with itself in order to generate an accumulated signal 425 based on the energy of the received signal 420, as described in more detail above in connection with FIG. 4. For this embodiment, energy detector 405 may also correlate each of a plurality of symbols with itself to generate the accumulated signal 425 in such a way as to provide for more accurate detection of the beacon signal 225.

For another embodiment, energy detector 405 correlates a current symbol in the received signal 420 with a previous symbol in order to generate an accumulated signal 425 based on the energy of the received signal 420, as described in more detail above in connection with FIG. 5. It will be understood that energy detector 405 may otherwise suitably detect the energy of the received signal 420.

Comparator 410 compares the detected energy to a detection threshold (process step 715). For example, comparator 410 may compare the accumulated signal 425 to the detection threshold. If the detected energy is not greater than the detection threshold (process step 720), comparator 410 generates a detection signal 430 that identifies the received signal 420 as noise (process step 725), and the method comes to an end.

However, if the detected energy is greater than the detection threshold (process step 720), comparator 410 generates a detection signal 430 that identifies the received signal 420 as a beacon signal 225 (process step 730). Beacon signal generator 415 then decodes the beacon signal 225 based on the detection signal 430 (process step 735), and the method comes to an end.

In this way, receiver 400 may detect a beacon signal 225 without a corresponding pilot signal. Because of this, protecting device 135 does not need to transmit a pilot signal and, thus, may transmit a beacon signal 225 substantially continuously. As a result, the beacon signal 225 may be detected relatively quickly based on the energy of the continuously-transmitted beacon signal 225 instead of based on a pilot signal.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting a beacon signal to facilitate quick beacon detection and protect a low-power device in a wireless network, comprising:
spreading each symbol of a beacon message with a fixed-length pseudorandom (PN) code to generate a beacon signal; and
transmitting the beacon signal without a corresponding pilot signal.

2. The method as set forth in claim 1, further comprising selecting the PN code from a plurality of possible PN codes.

3. The method as set forth in claim 2, selecting the PN code from a plurality of possible PN codes comprising randomly selecting the PN code from the possible PN codes.

4. The method as set forth in claim 1, transmitting the beacon signal comprising transmitting the beacon signal periodically in type-length-value format.

5. The method as set forth in claim 1, further comprising, after spreading each symbol of the beacon message, appending a message separation indicator to the spread beacon message to generate a beacon data block, the beacon signal comprising a plurality of repeating beacon data blocks.

6. The method as set forth in claim 1, the beacon message comprising type, length and value data.

7. A method for detecting a beacon signal operable to protect a low-power device at a receiver in a wireless network, comprising:
detecting an energy level of a received signal;
comparing the detected energy level to a detection threshold; and
identifying the received signal as a beacon signal when the detected energy level is greater than the detection threshold.

8. The method as set forth in claim 7, detecting the energy level of the received signal comprising correlating a symbol of the received signal with itself.

9. The method as set forth in claim 7, detecting the energy level of the received signal comprising correlating each of a plurality of symbols of the received signal with itself.

10. The method as set forth in claim 7, detecting the energy level of the received signal comprising correlating a current symbol of the received signal with a previous symbol of the received signal.

11. The method as set forth in claim 7, further comprising, when the received signal is identified as a beacon signal, decoding the beacon signal.

12. The method as set forth in claim 7, further comprising identifying the received signal as noise when the detected energy level is equal to or less than the detection threshold.

13. In a wireless network, a receiver capable of detecting a beacon signal operable to protect a low-power device, comprising:
an energy detector operable to detect an energy level of a received signal; and
a comparator coupled to the energy detector, the comparator operable to compare the detected energy level to a detection threshold and to identify the received signal as a beacon signal when the detected energy level is greater than the detection threshold.

14. The receiver as set forth in claim 13, the energy detector operable to detect the energy level of the received signal by correlating a symbol of the received signal with itself.

15. The receiver as set forth in claim 13, the energy detector operable to detect the energy level of the received signal by correlating each of a plurality of symbols of the received signal with itself.

16. The receiver as set forth in claim 13, the energy detector operable to detect the energy level of the received signal by correlating a current symbol of the received signal with a previous symbol of the received signal.

17. The receiver as set forth in claim 13, further comprising a beacon signal decoder coupled to the comparator, the beacon signal decoder operable to decode the beacon signal when the comparator identifies the received signal as a beacon signal.

18. The receiver as set forth in claim 13, the comparator further operable to identify the received signal as noise when the detected energy level is equal to or less than the detection threshold.

19. The receiver as set forth in claim 13, the energy detector comprising a single-symbol correlator and a two-symbol correlator.

20. The receiver as set forth in claim 19, the energy detector further comprising a spreader, a delay block, a complex conjugator, a complex square block, a square block, and a division block.
